(19) United States
(12) Patent Application Publication
(10) Pub. No.: US 2026/0273484 A1
(43) Pub. Date: Sep. 17, 2026

(54) WATER DISCHARGE DEVICE

(71) Applicant: LIXIL Corporation, Tokyo (JP)

(72) Inventor: Noritoshi OTA, Shinagawa-ku, Tokyo (JP)

(73) Assignee: LIXIL Corporation, Tokyo (JP)

(21) Appl. No.: 19/167,100

(22) PCT Filed: Mar. 20, 2023
(86) PCT No.: PCT/JP2023/010869

§ 371 Date: Sep. 19, 2025

(51) Int. Cl. B01F 35/10; B01F 23/20; B01F 23/235; B01F 25/452; B01F 35/45; B01F 101/48

(52) U.S. Cl. CPC B01F 35/10; B01F 23/235; B01F 23/291; B01F 25/4522; B01F 35/45; B01F 2101/48

(57) ABSTRACT

A water discharge device includes a foamer. The foamer includes: a foamer body having an opening at one end; a flow inlet through which a fluid flows into the foamer body; an agitation part that is housed in the foamer body and that generates foam by agitating the fluid; a flow outlet through which foam generated in the agitation part flows out of the foamer body; and a lid detachably provided on the opening of the foamer body. When the lid is detached from the opening of the foamer body, the agitation part can be removed from the foamer body through the opening.

### CROSS-REFERENCE TO RELATED APPLICATIONS

This application is a national stage application under 35 USC 371 of International Application No. PCT/JP2023/010869, filed Mar. 20, 2023, the entire contents of which are incorporated by reference herein.

### FIELD

The present invention relates to a water discharge device capable of discharging foam.

### BACKGROUND

Conventionally, a foamer is known to generate and discharge foam by agitating, in an agitation part, a gas-liquid mixture fluid obtained by mixing compressed air into mixed water, which is a mixture of a liquid containing a foaming component and water. Such a foamer includes porous bodies arranged in multiple stages along a flow path for the gas-liquid mixture fluid (see Japanese Patent Application Laid-Open Publication No. 2015-47236 and Japanese Patent Application Laid-Open Publication No. 2013-17948, for example).

### SUMMARY

### Technical Problem

With a foamer as described above, occurrence of limescale or metallic soap in the foamer is an issue. Limescale is a chalky deposit. A main component of limescale is lime (calcium carbonate) precipitated from water. In particular, since hard water contains hydrogencarbonate of calcium or magnesium and other salts, it is likely to generate limescale. Metallic soap is a combination of a soap component and calcium or magnesium in the water. When limescale or metallic soap occurs in the foamer, the porous bodies may become clogged, which may reduce the homogeneity and flow rate of the generated foam.

The present disclosure has been made in view of such an issue, and a purpose thereof is to provide a water discharge device with improved maintainability of the foamer.

### Solution to Problem

To solve the abovementioned issue, a water discharge device according to one embodiment of the present invention includes a foamer. The foamer includes: a foamer body having an opening at one end; a flow inlet through which a fluid flows into the foamer body; an agitation part that is housed in the foamer body and that generates foam by agitating the fluid; a flow outlet through which foam generated in the agitation part flows out of the foamer body; and a lid detachably provided on the opening of the foamer body. When the lid is detached from the opening of the foamer body, the agitation part can be removed from the foamer body through the opening.

### BRIEF DESCRIPTION OF DRAWINGS

FIG. 1 is an external perspective view of a water discharge device according to an embodiment.

FIG. 2 is an external perspective view of a portion of the inside of the water discharge device.

FIG. 3 is a block diagram that shows an illustrative configuration of a water passage system and an electrical circuit system of the water discharge device.

FIG. 4 is an external perspective view of a foamer.

FIG. 5 is a sectional perspective view of the foamer.

FIG. 6 is an external perspective view that shows a state where an agitation part has been removed from a foamer body.

FIG. 7 is a sectional perspective view of porous body supports and a lid.

FIG. 8 is an external perspective view that shows a state where the lid has been detached from the porous body housing member.

FIG. 9 is an external perspective view of a porous body.

FIG. 10 is a sectional perspective view of a foamer according to a modification.

### DETAILED DESCRIPTION

In the following, the present invention will be described based on a preferred embodiment with reference to the drawings. The configurations described below are intended for illustration for understanding of the present disclosure, and the scope of the present disclosure is defined only by the scope of the claims attached herein. Like reference characters denote like or corresponding constituting elements and members in each drawing, and repetitive description will be omitted as appropriate. Also, the dimensions of a member may be appropriately enlarged or reduced in each drawing in order to facilitate understanding. Further, in each drawing, part of a member less important in describing the embodiment may be omitted.

A water discharge device 1 according to the present embodiment discharges foam generated by mixing compressed air into mixed water, which is a mixture of a liquid containing a foaming component and water. The water discharge device 1 is mainly installed and used in a bathroom.

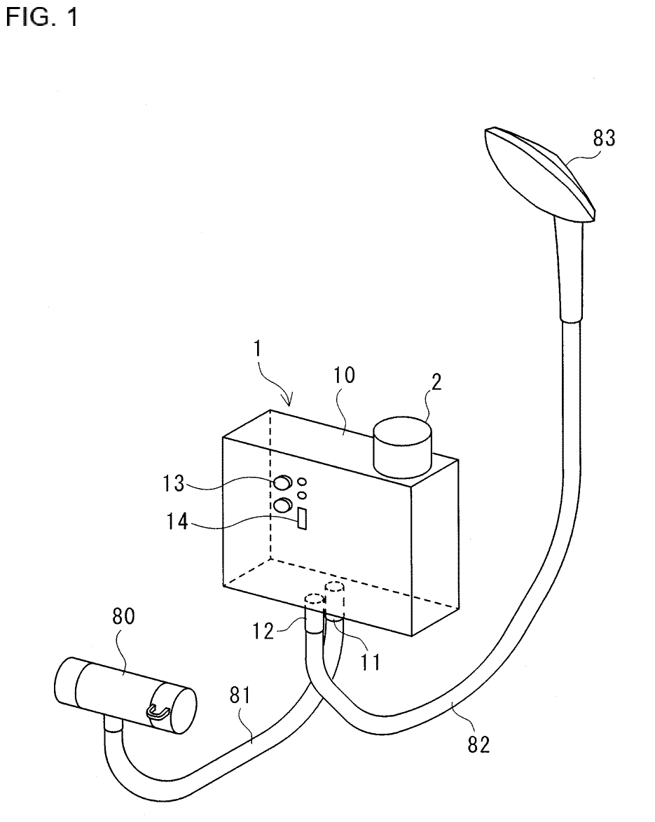

FIG. 1 is now referred to. A water discharge device 1 has a case 10 of rectangular parallelepiped shape that houses piping and various components. To a water supply inlet 11 of the water discharge device 1, a hose 81 extending from a water supply device 80 is connected, and water is supplied from the water supply device 80. The water supply device 80 has, for example, a temperature control function, a flow rate control function, and a function for switching between passing water and stopping water.

To a discharge outlet 12 of the water discharge device 1, a hose 82 of a shower head 83 is connected. The water discharge device 1 discharges one of water or foam through the discharge outlet 12, and the one of water or foam is discharged through the hose 82 and the shower head 83 to the outside. The water discharge device 1 may be connected to a device other than the shower head 83. Also, the water discharge device 1 may directly discharge one of water or foam to the outside. The water discharge device 1 may be configured to include a component for discharging, such as the shower head 83. The water discharge device 1 may have all or some of the functions of the water supply device 80.

In the water discharge device 1, a liquid replenishment container 2 is detachably connected to replenish a liquid containing a foaming component. As shown in FIG. 1, the liquid replenishment container 2 partially protrudes from the upper surface of the case 10 that covers the outside of the water discharge device 1. By adopting such a structure of the liquid replenishment container 2 partially protruding from the case 10, the device can be made more compact, compared to the case where a liquid tank is built into the case 10. In addition, by adopting the structure of the liquid replenishment container 2 partially protruding, the remaining amount of liquid in the liquid replenishment container 2 can be easily checked.

The attachment and detachment of the liquid replenishment container 2 can be easily performed by holding an upper part of the liquid replenishment container 2. By making the liquid replenishment container 2 easily replaceable, it is possible to realize a way of enjoying changing the type of liquid according to the mood of the day.

On the front of the case 10, an operation button 13, which can be operated by the user, and an indicator 14, which can be viewed by the user, are provided. The indicator 14 is constituted by a component such as an LED or a liquid crystal display. The size of the case 10 is, for example, about 15 cm in height, 20 cm in width, and 5 cm in depth. The size of the case 10 is not limited thereto. The indicator 14 may indicate the remaining amount of liquid in the liquid replenishment container 2. The remaining amount of liquid may be detected using a weight sensor or a water level detection sensor.

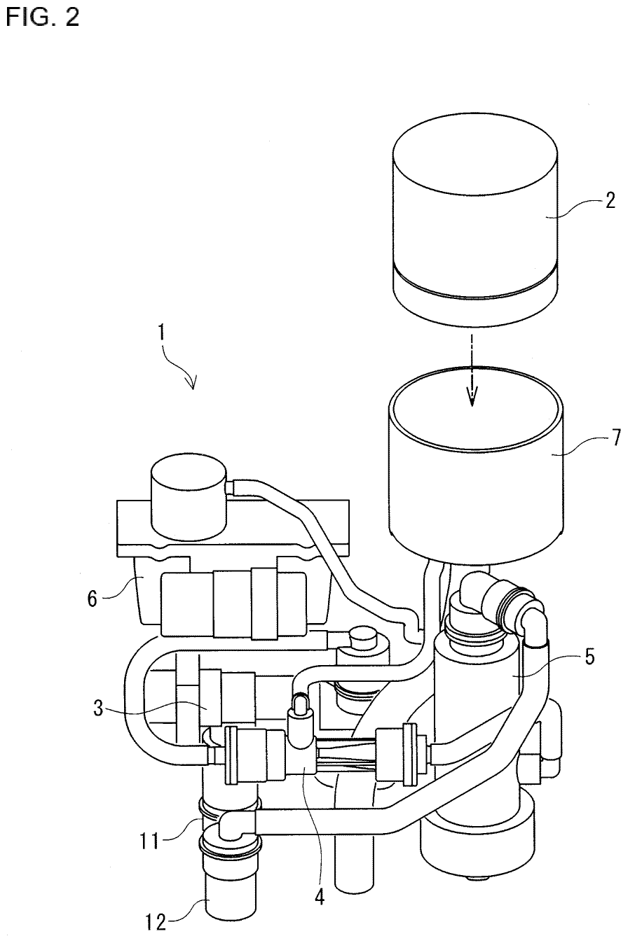

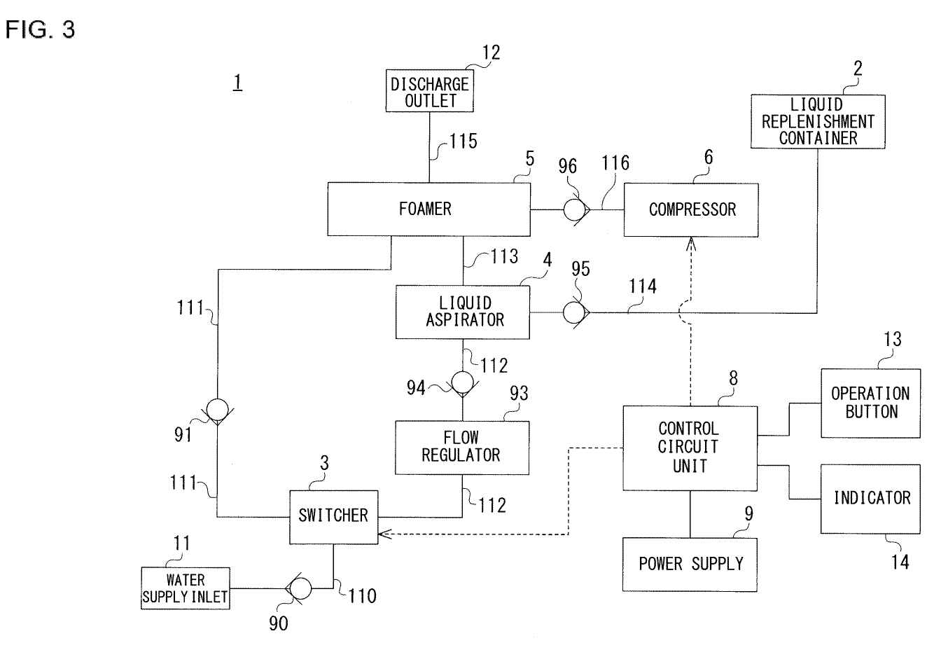

FIGS. 2 and 3 are now referred to. The water discharge device 1 includes a switcher 3, a liquid aspirator 4, a foamer 5, a compressor 6, a container mounting unit 7, a control circuit unit 8, and a power supply 9, for example. The container mounting unit 7 is configured such that the liquid replenishment container 2 can be attached thereto. To the downstream side of the water supply inlet 11 is connected a check valve 90, and the check valve 90 and the switcher 3 are connected by a flow path 110. The check valve 90 prevents backflow of water from the flow path 110 to the water supply inlet 11 side.

The switcher 3 switches passing water through a flow path 111 and a flow path 112 in two directions, which branch off from the flow path 110. One flow path 111 is connected to the foamer 5. A check valve 91 provided in the flow path 111 prevents backflow from the foamer 5 side to the switcher 3 side. The foamer allows the water from the flow path 111 to pass therethrough and flow into a flow path 115. The flow path 115 is connected to the discharge outlet 12.

In the other flow path 112, a flow regulator 93 and a check valve 94 are provided. The flow path 112 is connected to the liquid aspirator 4. The flow regulator 93 is constituted by a constant flow valve, a pressure reducing valve, or the like. The flow regulator 93 adjusts the flow rate on the downstream side to about 1 liter per minute, for example. The check valve 94 prevents backflow from the liquid aspirator 4 side to the switcher 3 side.

The liquid aspirator 4 is, for example, an ejector. The liquid aspirator 4 aspirates the liquid replenished from the liquid replenishment container 2 to mix it with the water flowing in from the flow path 112 and then flows the mixture into a flow path 113 on the downstream side. The liquid replenishment container 2 and the liquid aspirator 4 are connected by a flow path 114. In the flow path 114, a check valve 95 is provided to prevent backflow from the liquid aspirator 4 side to the liquid replenishment container 2 side.

In addition to the flow path 111 described above, the flow path 113 is also connected to the foamer 5. Through the flow path 113, the mixed water, which is a mixture of the liquid containing a foaming component and water, is supplied to the foamer 5. The foamer 5 generates foam by mixing compressed air from the compressor 6 with the mixed water supplied from the flow path 113 and flows the foam into the flow path 115. The compressor 6 sends compressed air to the foamer 5 through a flow path 116 for air. In the flow path 116, a check valve 96 is provided to prevent backflow from the foamer 5 side to the compressor 6 side. The foamer 5 forms fine bubbles, so that the water discharge device 1 is capable of discharging fine foam.

The control circuit unit 8 receives power supply from the power supply 9 and operates the switcher 3 and the compressor 6, for example. The power supply 9 is one of various batteries, such as a lithium-ion battery. The power supply 9 may be constituted by a power supply circuit for using electricity supplied from a household power supply. The control circuit unit 8 receives operation input from the operation button 13 connected thereto and operates the switcher 3 and the compressor 6, for example. The control circuit unit 8 also allows the indicator 14 to indicate information, such as the operating state of the water discharge device 1 or the remaining amount of the power supply 9.

The water discharge device 1 can switch between a mode of discharging water through the discharge outlet 12 (water discharge mode) and a mode of discharging foam through the discharge outlet 12, according to the operation on the operation button 13. In the mode of discharging water, the water supplied from the water supply inlet 11 is made to flow through the flow paths 111 and 115 by the switcher 3 and discharged through the discharge outlet 12, without foam being generated. In the mode of discharging foam (foam discharge mode), on the other hand, the water supplied from the water supply inlet 11 is made to flow through the flow paths 112, 113, and 115 by the switcher 3, and foam is formed and discharged through the discharge outlet 12.

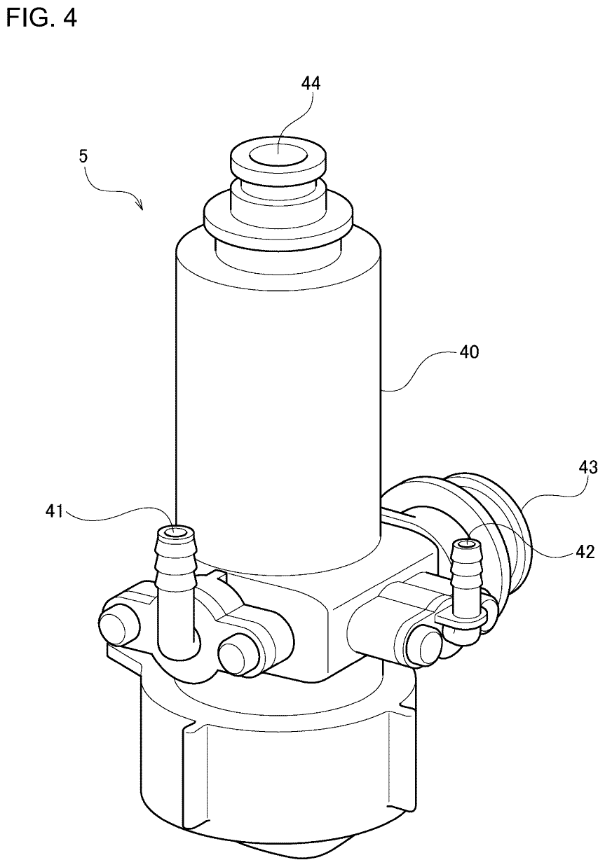

With reference to FIG. 4, the foamer 5 will be described. The foamer 5 generates foam by agitating, in an agitation part, a fluid flowing in from a flow inlet and discharges the foam through a flow outlet.

The foamer 5 includes a foamer body 40, a mixed liquid inlet 41, an air inlet 42, a tap water inlet 43, and a flow outlet 44. The foamer body 40 has a substantially circular cylindrical shape. The mixed liquid inlet 41, air inlet 42, and tap water inlet 43 are provided in a lower portion of the foamer body 40. The flow outlet 44 is provided at the upper end of the foamer body 40.

The flow path 113 is connected to the mixed liquid inlet 41, and mixed water obtained by mixing a liquid containing a foaming component and water flows from the liquid aspirator 4 into the mixed liquid inlet 41. The flow path 116 is connected to the air inlet 42, and compressed air from the compressor 6 flows into the air inlet 42. The flow path 111 is connected to the tap water inlet 43, and tap water from the water supply inlet 11 flows into the tap water inlet 43. The flow path 115 is connected to the flow outlet 44. The tap water or foam that flows out through the flow outlet 44 is sent to the discharge outlet 12 through the flow path 115 and discharged through the discharge outlet 12.

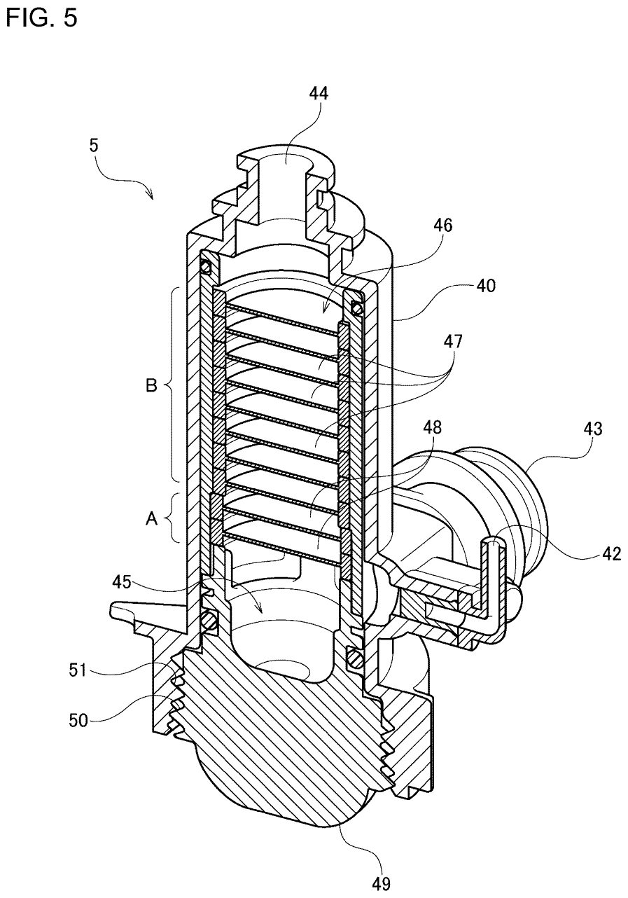

With reference to FIG. 5, the internal structure of the foamer 5 will be described. The foamer body 40 has a hollow substantially circular cylindrical shape and has an opening at one end (lower end). The lower end of the foamer body 40 is watertightly sealed by a lid 49. The shape of the foamer body 40 is not particularly limited and may be a hollow substantially polygonal cylindrical shape. In the internal space of the foamer body 40, an inflow part 45 and an agitation part 46, which is located downstream of (positionally, vertically above) the inflow part 45, are provided.

The inflow part 45 is a space where fluids from the mixed liquid inlet 41, air inlet 42, and tap water inlet 43 flow in. In the foam discharge mode, the mixed water from the mixed liquid inlet 41 and the compressed air from the air inlet 42 are mixed in the inflow part 45 to form a gas-liquid mixture fluid, which flows into the agitation part 46. In the water discharge mode, the tap water from the tap water inlet 43 passes through the inflow part 45 and the agitation part 46 as it is (without foam being generated) and is discharged through the flow outlet 44.

The agitation part 46 is located above (vertically above) the inflow part 45. The agitation part 46 includes porous bodies arranged in multiple stages along the direction of the fluid flow. More specifically, the agitation part 46 includes a pre-agitation section A where the fluid that has passed through the inflow part 45 flows in, and an agitation section B located downstream of the pre-agitation section A. In the pre-agitation section A, multiple pre-agitation porous bodies 48 having a relatively large porosity are provided. In the agitation section B located downstream of the pre-agitation section A, multiple agitation porous bodies 47 having a relatively small porosity are provided.

The “porous bodies” used in the present invention include porous members such as ceramic materials and sintered metal materials, woven or non-woven fabrics of metal or resin fibers, and meshes made of metal or resin wire rods (e.g., wire meshes).

In the agitation part 46 configured as described above, a gas-liquid mixture fluid, which flows in from the inflow part 45 and is in a roughly agitated state, is agitated by flow turbulence (rotating flow with non-uniform numerous vortices) generated when the gas-liquid mixture fluid passes through the pre-agitation porous bodies 48 with a relatively large porosity provided in the pre-agitation section A, which promotes homogenization and fining. Then, the gas-liquid mixture fluid of which the homogenization and fining has been promoted in the pre-agitation section A is further agitated by flow turbulence generated when the gas-liquid mixture fluid passes through the agitation porous bodies 47 with a relatively small porosity provided in the agitation section B, forming a fine and homogeneous foam fluid (foamed fluid) corresponding to the porosity of the agitation porous bodies 47 provided in the agitation section B. By sequentially agitating the gas-liquid mixture fluid in the pre-agitation section A where the pre-agitation porous bodies 48 with a relatively large porosity are provided and in the agitation section B where the agitation porous bodies 47 with a relatively small porosity are provided, pressure loss due to amplification of unnecessary flow turbulence can be suppressed, and a decrease in the limiting flow rate can also be prevented. Therefore, a fine and homogeneous foam fluid can be efficiently generated. Details of such an agitation part with multi-stage porous bodies are disclosed in the aforementioned Japanese Patent Application Laid-Open Publication No. 2013-17948.

As described previously, the lid 49 watertightly seals the opening at the lower end of the foamer body 40 of substantially circular cylindrical shape. The lid 49 is detachably provided on the opening of the foamer body 40. On the outer circumferential surface of the lid 49, a male thread 50 is formed; on the inner surface of the foamer body 40, a female thread 51 is formed. When the male thread 50 is threadedly engaged with the female thread 51, the lid 49 is fixed to the foamer body 40.

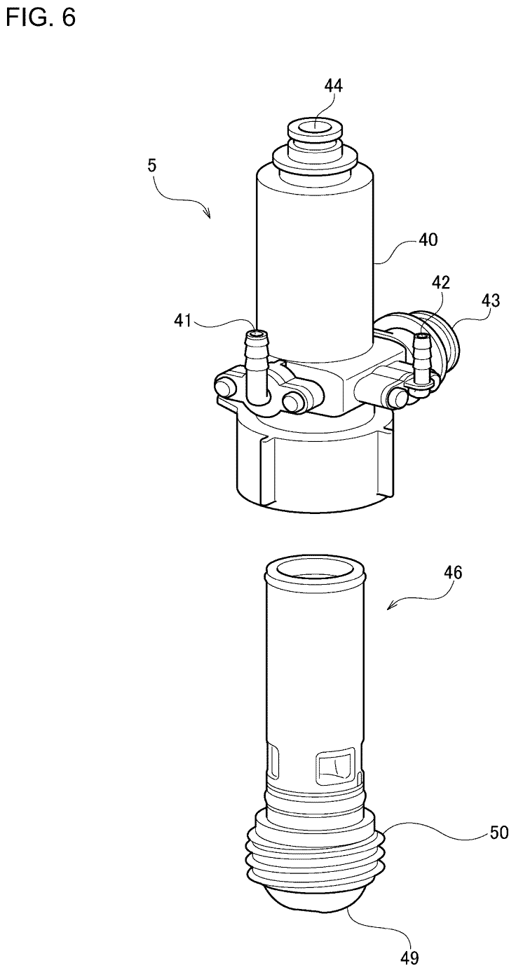

When the lid 49 is detached from the foamer body 40, the lid 49 is held and rotated with respect to the foamer body 40. This disengages the male thread 50 from the female thread 51, and the lid 49 can be detached from the foamer body 40, as shown in FIG. 6.

In the present embodiment, when the lid 49 is detached from the opening of the foamer body 40, the agitation part 46 can be removed from the foamer body 40 through the opening. Thus, by making the agitation part 46, in which limescale and metallic soap is likely to occur, removable from the foamer body 40, the maintainability of the foamer 5 can be improved.

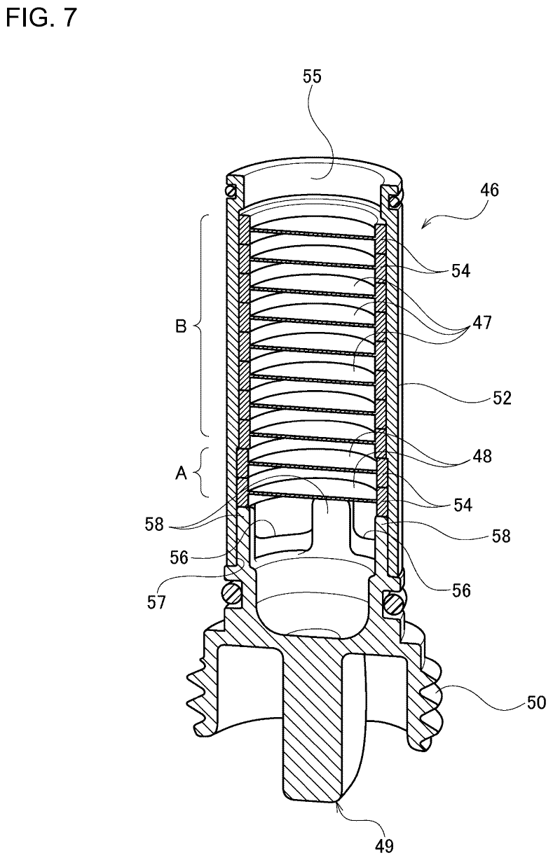

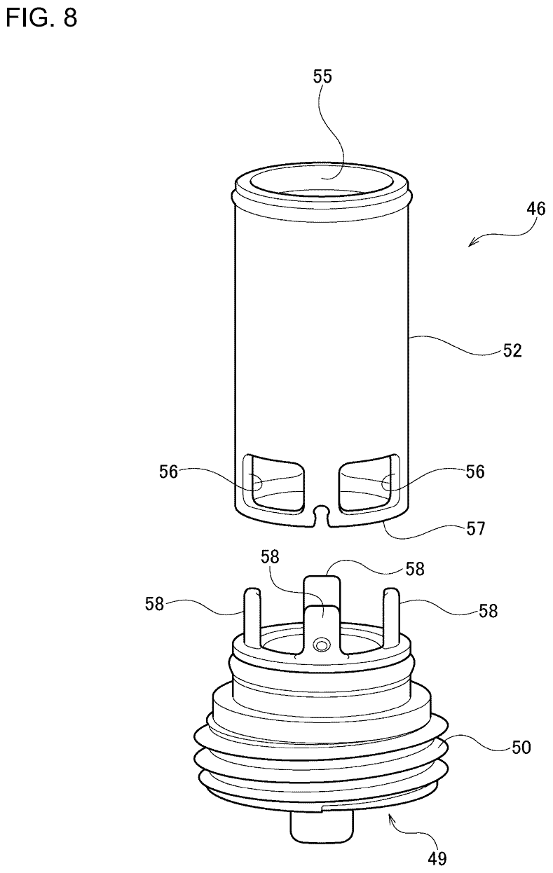

With reference to FIG. 7 and FIG. 8, the configuration of the agitation part 46 and the lid 49 will be described. In the present embodiment, the agitation part 46 and the lid 49 are fitted together and can be removed as a single unit from the foamer body 40. Therefore, the agitation part 46 can be removed more easily, compared to the case where the agitation part 46 and the lid 49 are separate. In another embodiment, the agitation part 46 and the lid 49 may be separate.

As described previously, the agitation part 46 includes multiple porous bodies (the pre-agitation porous bodies 48 and the agitation porous bodies 47). The agitation part 46 includes a porous body housing member 52 that houses the multiple porous bodies. The agitation part 46 has a substantially circular cylindrical shape with openings at both ends. The agitation part 46 may have another cylindrical shape, such as a substantially polygonal cylindrical shape.

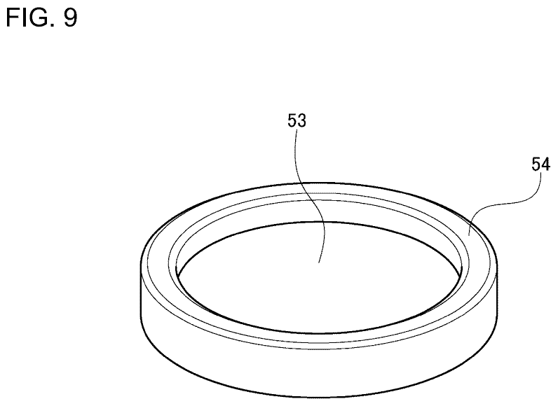

As described previously, the agitation part 46 includes the pre-agitation section A and the agitation section B. In the pre-agitation section A, the multiple pre-agitation porous bodies 48 are provided, and, in the agitation section B, the multiple agitation porous bodies 47 are provided. The multiple porous bodies are each held by a porous body holder 54. FIG. 9 illustrates a state where a porous body 53 is held by a porous body holder 54. The porous body holder 54 is an annular member having a predetermined thickness and holds the porous body 53 in a middle part in a thickness direction.

As illustrated in FIG. 7, multiple porous body holders 54 are stacked, and the multiple pre-agitation porous bodies 48 and agitation porous bodies 47 are housed in the porous body housing member 52. The thickness of each porous body holder 54 defines the interval between adjacent porous bodies. Considering attachment and detachment, the radial size of each porous body holder 54 may be slightly smaller than the inner diameter of the porous body housing member 52.

In the present embodiment, the pre-agitation porous bodies 48 and the agitation porous bodies 47 are different in size, and the sizes of the porous body holders 54 are also different accordingly. In the present embodiment, as shown in FIG. 7, the agitation porous bodies 47 are formed larger than the pre-agitation porous bodies 48. Thus, by making the pre-agitation porous bodies 48 and the agitation porous bodies 47 different in size, a situation can be prevented in which the pre-agitation porous bodies 48 and the agitation porous bodies 47 are placed in a wrong order in the porous body housing member 52.

In the porous body housing member 52, the housing space for the pre-agitation porous bodies 48 and the housing space for the agitation porous bodies 47 are different in size. As shown in FIG. 7, the thickness of the side wall of the porous body housing member 52 in the pre-agitation section A is formed thinner than that in the agitation section B. Therefore, the housing space for the pre-agitation porous bodies 48 in the pre-agitation section A is formed larger than the housing space for the agitation porous bodies 47 in the agitation section B. Thus, by making the sizes of the housing spaces different, the pre-agitation porous bodies 48 cannot be placed in the housing space for the agitation porous bodies 47, so that mistakes in the arrangement of the porous bodies can be prevented further preferably.

An opening 55 at the upper end of the porous body housing member 52 is used as a flow outlet of a fluid that has passed through the multiple porous bodies. The inner diameter of the opening 55 is formed smaller than the inner diameter of the porous body housing member 52 in the agitation section B, so that the porous body holder 54 for the top agitation porous body 47 is locked before reaching the opening 55.

On the side surface of a lower portion of the porous body housing member 52, inflow parts 56 are provided to introduce the fluids from the mixed liquid inlet 41, the air inlet 42, and the tap water inlet 43 into the porous body housing member 52.

On an opening 57 at the lower end of the porous body housing member 52, multiple porous body supports 58 that support the multiple porous bodies inside the porous body housing member 52 are detachably provided. The porous body supports 58 are members provided such as to protrude from the upper surface of the lid 49, and the upper ends thereof are in contact with the porous body holder 54 for the lowest pre-agitation porous body 48. By being sandwiched between the upper end of the porous body housing member 52 and the porous body supports 58, the multiple porous bodies are locked inside the porous body housing member 52.

The porous body supports 58 also serve as members for fitting the lid 49 to the porous body housing member 52. The porous body supports 58 are in contact with the inner wall surface of the porous body housing member 52 and locked, so that the porous body housing member 52 and the lid 49 are fitted together. By pulling the lid 49 away from the porous body housing member 52 and releasing the locking between the porous body supports 58 and the inner wall surface of the porous body housing member 52, the lid 49 can be detached from the porous body housing member 52, as illustrated in FIG. 8. Although the porous body supports 58 and the lid 49 are integrally formed in the present embodiment, they may be formed separately. In this case, another member may be formed on the lid 49 to be fitted to the porous body housing member 52.

By detaching the porous body supports 58 from the opening 57 of the porous body housing member 52, the agitation porous bodies 47 and the pre-agitation porous bodies 48 can be removed from the porous body housing member 52 through the opening 57. By enabling removal of the agitation porous bodies 47 and the pre-agitation porous bodies 48 from the porous body housing member 52, limescale and metallic soap adhering to the agitation porous bodies 47 and the pre-agitation porous bodies 48 can be easily cleaned using a brush or the like. Thus, in the water discharge device 1 according to the present embodiment, the maintainability of the foamer 5 can be greatly improved.

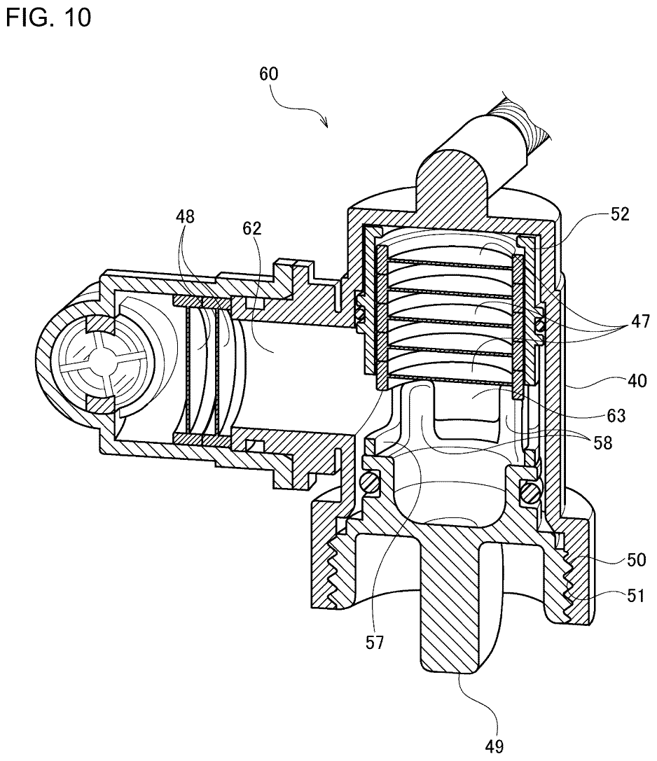

With reference to FIG. 10, a foamer 60 according to a modification will be described. In the foamer 60, the pre-agitation porous bodies 48 and the agitation porous bodies 47 are arranged in different flow paths. The pre-agitation porous bodies 48 are arranged in a pre-agitation flow path 62 extending to a side of the foamer body 40. The agitation porous bodies 47 are arranged in an agitation flow path 63 extending in a direction perpendicular to the pre-agitation flow path 62. The agitation porous bodies 47 are housed in the porous body housing member 52 while being supported by the porous body supports 58.

By rotating the lid 49 with respect to the foamer body 40 and disengaging the male thread 50 from the female thread 51, the porous body housing member 52 and the lid 49 can be removed as a single unit from the foamer body 40. Then, by detaching the lid 49 from the opening 57 of the porous body housing member 52, the agitation porous bodies 47 can be removed from the porous body housing member 52 through the opening 57. Thus, in the foamer 60 according to the modification, only the agitation porous bodies 47 can be removed from the foamer body 40 for maintenance.

The present invention has been described with reference to an embodiment. The embodiment is intended to be illustrative only, and it will be obvious to those skilled in the art that various modifications and changes could be developed within the scope of claims of the present invention and that such modifications and changes also fall within the scope of claims of the present invention. Therefore, the description in the present specification and the drawings should be regarded as illustrative rather than limitative.

1. A water discharge device comprising a foamer,
the foamer comprising:
a foamer body having an opening at one end;
a flow inlet through which a fluid flows into the foamer body;
an agitation part that is housed in the foamer body and that generates foam by agitating the fluid;
a flow outlet through which foam generated in the agitation part flows out of the foamer body; and
a lid detachably provided on the opening of the foamer body,
wherein, when the lid is detached from the opening of the foamer body, the agitation part can be removed from the foamer body through the opening.

2. The water discharge device of claim 1, wherein the agitation part and the lid are fitted together and can be removed as a single unit from the foamer body.

3. The water discharge device of claim 1,
wherein the agitation part comprises:
a plurality of porous bodies;
a porous body housing member that has a substantially cylindrical shape having an opening and that houses the plurality of porous bodies; and
a porous body support that is detachably provided on the opening of the porous body housing member and that supports the plurality of porous bodies inside the porous body housing member, and
wherein, when the porous body support is detached from the opening of the porous body housing member, the plurality of porous bodies can be removed from the porous body housing member through the opening.

4. The water discharge device of claim 3, wherein the porous body support is integrally formed with the lid.

5. The water discharge device of claim 3 4,
wherein the plurality of porous bodies are each held by a porous body holder, and
wherein a plurality of the porous body holders are stacked, and the plurality of porous bodies are housed in the porous body housing member.

6. The water discharge device of claim 5, wherein the thicknesses of the porous body holders define the intervals between the porous bodies.

7. The water discharge device of claim 3, wherein the plurality of porous bodies include a plurality of pre-agitation porous bodies having a relatively large porosity, and a plurality of agitation porous bodies having a relatively small porosity.

8. The water discharge device of claim 7, wherein the pre-agitation porous body and the agitation porous bodies are different in size.

9. The water discharge device of claim 8, wherein, in the porous body housing member, a housing space for the pre-agitation porous body and a housing space for the agitation porous bodies are different in size.
